(19) United States
(12) Patent Application Publication
(10) Pub. No.: US 2025/0260586 A1
(43) Pub. Date: Aug. 14, 2025

(54) ELECTRONIC SYSTEM WITH TRIPARTITE AUTHENTICATION BETWEEN A USER, A SENSOR AND THE ELECTRONIC SYSTEM

(71) Applicant: COMMISSARIAT A L'ENERGIE ATOMIQUE ET AUX ENERGIES ALTERNATIVES, Paris (FR)

(72) Inventors: Angélique RASCLE, Grenoble Cedex 09 (FR); Florian PEBAY-PEYROULA, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/625,364

(22) Filed: Apr. 3, 2024

(30) Foreign Application Priority Data
Apr. 5, 2023 (FR) 2303377

(51) Int. Cl. H04L 9/32

(52) U.S. Cl. CPC H04L 9/3278

(57) ABSTRACT

An electronic system carrying out a challenge-response type authentication of a user and of a sensor, including the sensor authenticating the user and including a PUF; a memory device memorising valid identification data of the user and of the sensor; a calculator; the electronic system being configured to implement the challenge-response type authentication of the sensor. Response data of the sensor are generated by the PUF of the sensor. Then, once the sensor is authenticated as being valid, the electronic system implements the challenge-response type authentication of the user, during which data exchanged between the calculator and the sensor are encrypted using a first encryption key calculated based on challenge data of the sensor and the response data of the sensor, the first encryption key being shared between the calculator and the sensor.

### TECHNICAL FIELD OF THE INVENTION

The field of the invention is that of data security, and in particular that of electronic systems fitted with measurement sensors for the authentication of users of these systems and wherein a high security of the processed data is required.

### PRIOR ART

Embedded electronic systems are increasingly close to user, and even carried by these users as is the case for example of smartwatches, augmented-, virtual- or mixed-reality glasses, etc. Therefore, these systems could measure parameters specific to the users and which might be considered as personal and/or confidential by the user. For example, smartwatches or extended-reality glasses could measure physical parameters from which it is possible to extract information, or function, that are considered as critical or sensitive, such as physiological information that could indicate a fatigue condition, a stress condition, a mental or emotional condition, or a health condition of the user. The measured parameters could also be used to generate assistance information or to display action or decision support information that the user should complete, for example in an emergency situation. In this context, it is interesting to propose and establish a high level of confidence between the user and the information displayed by the system especially in emergency situations so that the user has no doubt regarding the reliability of this information.

The document US 2017/111356 A1 describes an electronic system wherein an authentication of the user is ensured by two biochemical measurements compared with databases of measurements carried out beforehand on the user. Nonetheless, such a system does not provide an optimum security of the processed data because it does not ensure the integrity of the measurements carried out throughout the operation chain of the electronic system processing these measurements.

The document US 2019/312740 A1 covers the security of sensors based on the use of a PUF (“Physical Unclonable Function”) generated based on data of a calibrated first sensor. A non-calibrated second sensor is also used, and the generated PUF is compared with a database of identification PUFs of the sensor. The data used for the generation of the PUF may correspond to physical or chemical signals obtained in the first sensor. This document does not provide a system wherein an authentication of the user is secured throughout the operation chain of the system processing the completed authentication measurements.

### DISCLOSURE OF THE INVENTION

The present invention aims to overcome all or part of the above-mentioned drawbacks of the prior art, and in particular to propose an electronic system fitted with a measuring sensor for authenticating a user and wherein the processing chain of the measurement data intended to be obtained from the user is completely secure.

For this purpose, an electronic system is provided configured to carry out a challenge-response type (or “challenge-response” in English) authentication of a user and of a sensor, comprising at least:
the sensor which is configured to carry out at least one authentication measurement of the user and comprising a PUF;
a memory device configured to memorise at least valid identification data of the user and valid identification data of the sensor intended to be obtained prior to the challenge-response type authentication of the user;
a calculator configured to communicate with the sensor and the memory device, and to process data intended to be sent by the sensor and the memory device to the calculator;
the electronic system being configured to:
implement the challenge-response type authentication of the sensor, wherein response data of the sensor are intended to be generated by the PUF of the sensor, then
once the sensor is authenticated as being valid, i.e. as being the sensor that is actually intended to carry out the authentication measurement(s) of the user, implement the challenge-response type authentication of the user, during which data intended to be exchanged between the calculator and the sensor are encrypted using a first encryption key calculated based on challenge data of the sensor and the response data of the sensor, the first encryption key being intended to be shared between the calculator and the sensor.

First of all, the proposed electronic system carries out an authentication of the measuring sensor which will be used to authenticate the user, this authentication of the sensor involving a PUF of the sensor in order to achieve a great reliability for this authentication. After the sensor has been authenticated as being a valid sensor, the user of the system is authenticated afterwards by using this sensor to carry out the authentication measurement(s) on the user, and by also using a first encryption key calculated based on the challenge data and the response data of the sensor obtained during the authentication of the senor, this first encryption key being shared between the calculator and the sensor. Thus, the electronic system not only guarantees that the authentication measurement is carried out on the user by a sensor that is authenticated beforehand, but also guarantees that the data exchanged afterwards with the sensor during the authentication of the user are exchanged in a secure manner thanks to the used first encryption key.

Thus, for example, the proposed electronic system allows achieving a very high level of confidence between the user and information displayed by the system, in particular in emergency situation, so that the user has no doubt regarding the reliability of this information.

In particular, the proposed electronic system could be used against the following threats:
an attacker modifying the sensor so that it produces erroneous data;
   an attacker injecting fake data towards the electronic system by substitution of the user (the electronic system believing receiving measurements from a user but actually receiving those of another user or fictitious corrupted measurements) or by taking control of the link between the sensor and the calculator to send factitious data towards the sensor (to cause an authentication of the user by the sensor and for example to reuse the data in another context) or towards the calculator (for example to enable the authentication of another user);
   an attacker drawing confidential data originating from the sensor and exploiting them afterwards without the user's knowledge;
an attacker modifying the confidential data originating from the sensor to deceive the system.

In order to guarantee the security of the processed data, the proposed electronic system complies with the rules generally so-called the C.I.A. rules and which consist in:
guaranteeing the authenticity of the data, i.e. guaranteeing that the data originate from an authenticated device or belonging to a mutual authentication scheme (the device is authenticated and the device authenticates the user);
guaranteeing the confidentiality of the data, i.e. that they are accessible only to authorised persons, and that being so throughout the service life of the system;
guaranteeing the integrity of the data, i.e. that they are altered due to inadvertence or to a failure.

The sensor of the electronic system corresponds to a biometric sensor or a sensor coupled to a biometric sensor (for example a sensor supplying a complementary piece of information to a biometric sensor from which it is possible to extract a piece of information specific to a user, for example an accelerometer, a gyroscope, etc.) configured to carry out at least one measurement of at least one parameter specific to the user, i.e. carry out a measurement of at least one biochemical and/or biophysical parameter and which is not reproducible by another user. For example, the sensor may correspond to a fingerprint sensor.

The electronic system may be configured to implement, prior to the challenge-response type authentication of the sensor, an enrolment of the sensor and/or of the user allowing obtaining the valid identification data of the user and the valid identification data of the sensor. For example, the enrolment of the sensor may consist in applying, at the input of the PUF of the sensor, different challenge data of the sensor, and in memorising afterwards, in the memory device, the responses generated by the PUF of the sensor according to the challenge data applied at the input of the PUF of the sensor. In particular, such an enrolment of the sensor may be implemented when the PUF of the sensor is of the “strong-PUF” type. Furthermore, the enrolment of the user may consist in carrying out several measurements for authenticating the user and in memorising the data corresponding to these authentication measurements of the user in the memory device.

The PUF of the sensor may belong to either one of the two major PUF families which are “weak-PUF” and “strong-PUF”.

In the case where the PUF of the sensor is of the “strong-PUF” type, the electronic system may be configured to carry out the challenge-response type authentication of the sensor by implementing the following steps:
recovering, by the calculator, the challenge data of the sensor memorised in the memory device, then
sending, from the calculator to the sensor, the challenge data of the sensor, then
sending, from the sensor to the calculator, the response data of the sensor generated by the PUF of the sensor by having applied the challenge data of the sensor at the input of the PUF, then
sending, from the calculator to the memory device, the response data of the sensor, then
comparing the response data of the sensor and the valid identification data of the sensor, the sensor being authenticated as being valid if the response data of the sensor correspond to the valid identification data of the sensor.

Thus, in the case where the PUF of the sensor is of the “strong-PUF” type, the calculator may send a challenge C to the sensor which generates, by its PUF, a response R specific to the challenge C. Afterwards, this response R is sent to the calculator and then to the memory device for comparison with the expected response.

In the case where the PUF of the sensor of the “weak-PUF” type, the electronic system may be configured to carry out the challenge-response type authentication of the sensor by implementing the following steps:
sending, from the calculator to the sensor, the challenge data of the sensor corresponding to a request for identification data generated by the PUF of the sensor, then
sending, from the sensor to the calculator, the response data of the sensor that correspond to the identification data generated by the PUF of the sensor, then
sending, from the calculator to the memory device, the response data of the sensor, then
comparing the response data of the senso and the valid identification data of the sensor, the sensor being authenticated as being valid if the response data of the sensor correspond to the valid identification data of the sensor.

Thus, if the PUF of the sensor is of the “weak-PUF” type, the calculator sends to the sensor a request for its identification data generated by the PUF (the identification data generated by the PUF of the sensor corresponding for example to a unique key generated by the PUF or a piece of information derived from this key). Afterwards, these identification data are sent to the calculator and then to the memory device in order to be compared with the valid identification data of the sensor.

The electronic system may be configured to carry out the challenge-response type authentication of the user by implementing the following steps:
recovering, by the calculator, challenge data of the user memorised in the memory device, then
sending, from the calculator to the sensor, the challenge data of the user encrypted using the first encryption key, then
authentication measurement of the user by the sensor using the decrypted challenge data of the user, then
sending, from the sensor to the calculator, response data of the user corresponding to the authentication measurement of the user by the sensor, encrypted using the first encryption key, then
sending, from the calculator to the memory device, the decrypted response data of the user, then
comparing the response data of the user and the valid identification data of the user, the user being authenticated as being valid if the response data of the user correspond to the valid identification data of the user.

The electronic system may be configured to:
calculate, after the challenge-response type authentication of the user, a second encryption key based on the challenge data of the user and the response data of the user, the second encryption key being shared between the calculator and the sensor, then
calculate a third encryption key obtained based on the first and second encryption keys and shared between the calculator and the sensor, then
exchange encrypted data between the sensor and the calculator using the third encryption key.

The electronic system may be configured to implement, periodically or not, and after a first challenge-response type authentication of the user:
another challenge-response type authentication of the sensor, wherein the response data of the sensor are intended to be generated by the PUF of the sensor, and/or
another challenge-response type authentication of the user, during which the data exchanged between the calculator and the sensor are encrypted using the first encryption key or another encryption key calculated based on the challenge data of the sensor and the response data of the sensor obtained during another challenge-response type authentication of the sensor.

In a particular configuration, the memory device may include a database remote from the sensor and from the calculator.

The sensor and the calculator may be part of an electronic device corresponding to a smartphone, or an electronic watch connected to the Internet, or extended-reality glasses connected to the Internet.

The invention also relates to a method for challenge-response type authentication of a user, implemented in an electronic system as described hereinabove.

### BRIEF DESCRIPTION OF THE FIGURES

Other advantages, aims and particular features of the present invention will appear from the following non-limiting description of at least one particular embodiment of the devices and methods objects of the present invention, with reference to the appended drawings, wherein:

FIG. 1 is a schematic illustration of an electronic system, object of the present invention, according to a particular embodiment;

FIG. 2 is a schematic illustration of the elements of a sensor of an electronic system, object of the present invention;

FIG. 3 is a diagram showing the steps implemented during an authentication of a user by the electronic system, object of the present invention, according to a particular embodiment.

### DETAILED DESCRIPTION OF THE INVENTION

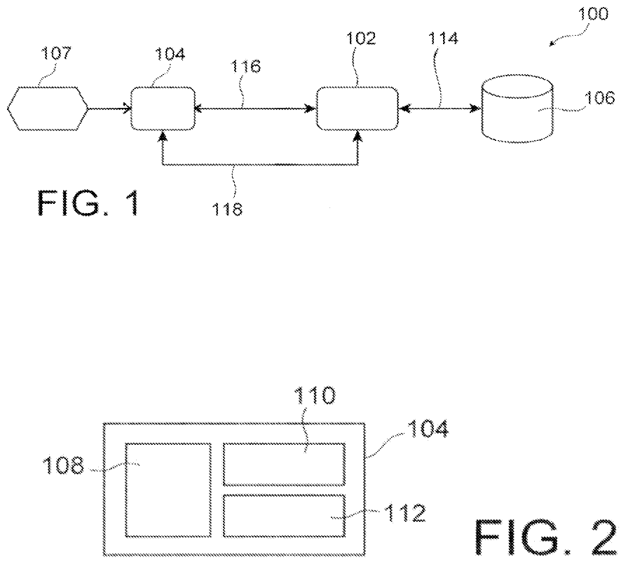

An embodiment of an electronic system 100 according to a particular embodiment is described hereinbelow with reference to FIG. 1.

The system 100 includes at least the following elements: a calculator 102, a sensor 104 and a memory device 106. In FIG. 1, the user is designated by the reference 107.

For example, the calculator 102 corresponds to a CPU (“Central Processing Unit”), a microcontroller, an application-specific processor, or any other electronic computing device.

For example, the sensor 104 is configured to carry out at least one biometric measurement for authenticating the user of the system 100 and comprises a PUF. This PUF is obtained using one or more electronic component(s) of the sensor 104. Alternatively, the sensor 104 may correspond to a sensor coupled to a biometric sensor (for example a sensor supplying a complementary piece of information to a biometric sensor from which it is possible to extract a piece of information specific to a user, for example an accelerometer, a gyroscope, etc.).

For example, the sensor 104 includes several elements as schematised in FIG. 2:
a measuring device 108 transforming the biophysical and/or biochemical information measured on the user into an analog electrical signal;
a digital interface 110 carrying out the shaping of the measurement analog signal into a digital signal and ensuring the digital communication of this signal towards the calculator 102;
a volatile memory 112, advantageously secured against physical attacks, which allows keeping the information necessary to the processing, to the exchange and/or to securing of the measurement carried out by the sensor 104 temporarily accessible.

According to a particular embodiment, the sensor 104 may correspond to a biometric sensor like for example a fingerprint sensor.

The sensor 104 may be part of a device also including the calculator 102 and with which the user is intended to authenticate or to be authenticated, like for example a smartphone, an electronic watch connected to the Internet or extended-reality glasses connected to the Internet.

According to an advantageous embodiment, the memory device 106 may correspond to a database remote from the sensor 104 and from the calculator 102. In this case, the memory device 106 could communicate with the calculator 102 via at least one communication network, for example the Internet. Alternatively, the memory device 106 may correspond to a local memory belonging to the device including the sensor 104 and the calculator 102 and communicating for example with the calculator 102 without passing through a network external to the device.

Furthermore, the calculator 102 communicates with the memory device 106 via a confidential link 114, and with the sensor 104 via a confidential link 116. The confidential links 114 and 116 correspond to wired or wireless secure communication channels which are protected in terms of confidentiality and integrity.

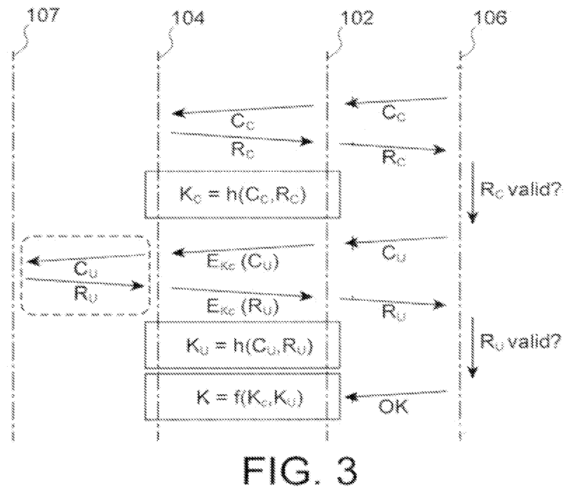

A challenge-response type authentication of the user, with a prior challenge-response type authentication of the sensor 104 wherein the response of the sensor 104 is generated by the PUF of the sensor 104, implemented by the system 100 are described hereinbelow. Part of the data exchanges carried out during these authentications are schematically illustrated in FIG. 3.

Before carrying out the authentication of the sensor 104, an enrolment of the sensor 104 and an enrolment of the user are implemented at first.

In the case where the PUF of the sensor 104 is of the “strong-PUF” type, the enrolment of the sensor 104 is carried out for example by sending numerous different challenge data to the sensor 104 and by recording in the memory device 106 the response data sent back by the PUF of the sensor 104 when these challenge data are applied at the input of the PUF of the sensor 104. In this case, the enrolment of the sensor 104 may correspond to the construction, in the memory device 106, of a table giving, for each of the different challenge data of the sensor, response data of the sensor expected for each of these challenge data.

In the case where the PUF of the sensor 104 is of the “weak-PUF” type, the enrolment of the sensor 104 may correspond to recording, in the memory device 106, the identification data generated by the PUF of the sensor 104 corresponding for example to a key generated by the PUF or a piece of information derived from this key.

For example, the enrolment of the user is obtained by carrying out different measurements by the sensor 104 and by recording in the memory device 106 the response data corresponding to these authentication measurements of the user.

Afterwards, the authentication of the sensor 104 is implemented. In the case where the PUF of the sensor 104 is of the “strong-PUF” type, the calculator 102 asks the memory device 106 to supply, among all of the memorised challenge data of the sensor 104 and via the confidential link 114, challenge data of the sensor, designated Cc in FIG. 3, allowing implementing a challenge of the sensor 104. For example, these challenge data of the sensor correspond to calibration data with which the sensor 104 could make a reference measurement, or a measurement of parameters (for example defects) specific to the sensor 104 during the manufacturing chain thereof. Afterwards, the challenge data of the sensor Cc are sent by the calculator 102 to the sensor 104. The challenge data of the sensor Cc are submitted at the input of the sensor 104 so that the PUF of the sensor 104 generates response data of the sensor, designated R_{C} in FIG. 3. The response data of the sensor R_{C} are specific to the challenge data of the sensor Cc used for the challenge applied to the sensor 104. The response data of the sensor R_{C} are sent to the calculator 102 which retransmits them to the memory device 106. The authenticity of the sensor 104 is verified by the memory device 106 by comparing the response data of the sensor R_{C} with the expected response, also so-called valid identification data of the sensor and which corresponds to the response data obtained during the enrolment of the sensor 102 when these challenge data of the sensor Cc have been applied at the input of the PUF of the sensor 104.

In the case where the PUF of the sensor 104 is of the “weak-PUF” type, the calculator 102 sends to the sensor 104 the challenge data of the sensor Cc which correspond, in this case, to a request for identification data generated by the PUF of the sensor 104. This identification request is submitted at the input of the sensor 104 so that the PUF of the sensor 104 generates the response data of the sensor R_{C} which correspond, for example, to a key generated by the PUF or a piece of information derived from this key. The response data of the sensor R_{C} are sent from the sensor 104 to the calculator 102, then to the memory device 106. Afterwards, the authenticity of the sensor 104 is verified by comparing the response data of the sensor R_{C} with the expected response obtained during the enrolment of the sensor 102.

Once the sensor 104 is authenticated, the process could continue.

At this stage, a first encryption key, designated K_{C} in FIG. 3, is calculated, for example with a condensate function h taking as a parameter the challenge data of the sensor Cc and the response data of the sensor R_{C}. For example, this condensate function carries out a concatenation of the data Cc and R_{C} and a condensate function for example of the SHA-256 type. In FIG. 1, the secure link formed between the calculator 102 and the sensor 104 and involving the first encryption key K_{C} is symbolised by the reference 118. Thus, after authentication of the sensor 104, the data exchanges between the sensor 104 and the calculator 102 may be carried out through the secure link 118 instead of the confidential link 116.

After authentication of the sensor 104, the challenge-response type authentication of the user is implemented, during which data exchanged between the calculator 102 and the sensor 104 are encrypted using the first encryption key K_{C} shared between the calculator 102 and the sensor 104.

For this purpose, the calculator 102 recovers challenge data of the user, designated C_{U} in FIG. 3, memorised in the memory device 106 and belonging to the valid identification data of the user obtained before during the enrolment of the user. For example, in the case of a sensor 104 corresponding to a fingerprint, the challenge data of the user may correspond to a signal controlling the illumination of the finger of the user by the sensor 104. Afterwards, the data C_{U} are transmitted to the sensor 104 using the secure link 118, i.e. by encrypting these data with the first encryption key K_{C}. In FIG. 3, the data C_{U} encrypted with the key K_{C} are designated E_{KC}(C_{U}). The sensor 104 decrypts the received message to reconstitute the unencrypted data C_{U}. Afterwards, a measurement for authenticating the user 107 by the sensor 104 is carried out, then the response data of the user, designated RU in FIG. 3, corresponding to the authentication measurement of the user 107 by the sensor 104, are sent from the sensor 104 to the calculator 102. For this transmission, the data R_{U} are encrypted using the first encryption key K_{C}, these encrypted data being designated EK_{C}(R_{U}) in FIG. 3. The data R_{U} are decrypted by the calculator 102, then transmitted to the memory device 106 and compared with the expected response data, i.e. the valid identification data of the user. The user is authenticated as being valid if the data R_{U} correspond to the valid identification data of the user.

After the challenge-response type authentication of the user, a second encryption key K_{U} may be calculated based on the challenge data of the user C_{U} and the response data of the user R_{U}, for example with the hash function h taking as parameters the data C_{U} and Ru. Thus, the calculator 102 and the sensor 104 share a key K_{C} specific to the sensor/calculator pair and a key K_{U} specific to the user/calculator pair.

Afterwards, a third encryption key K may be calculated based on the first and second encryption keys K_{C}, K_{U} and shared between the calculator 102 and the sensor 104. For example, this third key K is obtained by carrying out a condensate of the concatenated two keys K_{C}, K_{U}, or by carrying out an “exclusive OR” type operation between the two keys K_{C}, K_{U}. Other ways for calculating the key K are possible. Afterwards, the calculated third key K may be used to exchange encrypted data between the sensor 104 and the calculator 102, and to guarantee the confidentiality of the data in the processing chain of the system 100. The key K may be used to encrypt the stored data originating from the sensor 104, this key K being therefore required to decrypt the encrypted data originating from the sensor 104.

In a particular embodiment, the calculator 102 may use a corrector code in order to be able to regenerate the encryption key used to encrypt the data exchanged between the sensor 104 and the calculator 102, in the event of disturbances. For example, a “helper data” type element, as described for example in the document by Jeroen Delvaux et al., “Helper Data Algorithms for PUF-Based Key Generation: Overview and Analysis”, 2015, may be included in the calculator 102 and the sensor 104 in order to be capable of correcting the extracted piece of data in the event of a disturbance.

In the calculator 102, a secure routine could be executed to interface the calculator 102 with the sensor 104 and then generate the encryption key K in a secure manner. Thus, the use of a “Trust Execution Environment” (TEE) type secure enclave could enable the generation, the storage and the use of this key in a secure manner. In the sensor 104, a dedicated digital circuit may be associated in an integrated circuit of the sensor 104 to extract the authentication data and generate the encryption key K which is stored in an internal register or a secure memory of the sensor 104.

The electronic system 100 may be configured to implement, periodically or not, and after a first challenge-response type authentication of the user:
another challenge-response type authentication of the sensor 104, wherein the response data of the sensor are intended to be generated by the PUF of the sensor 104, and/or
another challenge-response type authentication of the user, during which the data exchanged between the calculator 102 and the sensor 104 are encrypted using the first encryption key K_{C} or another encryption key calculated based on the challenge data of the sensor and the generated response data of the sensor obtained during said other challenge-response type authentication of the sensor.

Thus, the security of the system 100 is improved because the authenticity of the sensor 104 and/or of the user is verified again after the first authentication of the user.

1. An electronic system configured to carry out a challenge-response type authentication of a user and of a sensor, comprising at least:
the sensor which is configured to carry out at least one authentication measurement of the user and comprising a PUF;
a memory device configured to memorise at least valid identification data of the user and valid identification data of the sensor intended to be obtained prior to the challenge-response type authentication of the user;
a calculator configured to communicate with the sensor and the memory device, and to process data intended to be sent by the sensor and the memory device to the calculator;
wherein the electronic system is configured to:
implement the challenge-response type authentication of the sensor, wherein response data of the sensor are intended to be generated by the PUF of the sensor, then
once the sensor is authenticated as being valid, implement the challenge-response type authentication of the user, during which data intended to be exchanged between the calculator and the sensor are encrypted using a first encryption key calculated based on challenge data of the sensor and the response data of the sensor, the first encryption key being intended to be shared between the calculator and the sensor.

2. The electronic system according to claim 1, wherein the electronic system is configured to implement, prior to the challenge-response type authentication of the sensor, an enrolment of the sensor and/or of the user allowing obtaining the valid identification data of the user and the valid identification data of the sensor.

3. The electronic system according to claim 1, wherein the electronic system is configured to carry out the challenge-response type authentication of the sensor by implementing the following steps:
recovering, by the calculator, the challenge data of the sensor memorised in the memory device, then
sending, from the calculator to the sensor, the challenge data of the sensor, then
sending, from the sensor to the calculator, the response data of the sensor generated by the PUF of the sensor by having applied the challenge data of the sensor at the input of the PUF, then
sending, from the calculator to the memory device, the response data of the sensor, then
comparing the response data of the sensor and the valid identification data of the sensor, the sensor being authenticated as being valid if the response data of the sensor correspond to the valid identification data of the sensor.

4. The electronic system according to claim 1, wherein the electronic system is configured to carry out the challenge-response type authentication of the sensor by implementing the following steps:
sending, from the calculator to the sensor, the challenge data of the sensor corresponding to a request for identification data generated by the PUF of the sensor, then
sending, from the sensor to the calculator, the response data of the sensor that correspond to the identification data generated by the PUF of the sensor, then
sending, from the calculator to the memory device, the response data of the sensor, then
comparing the response data of the sensor and the valid identification data of the sensor, the sensor being authenticated as being valid if the response data of the sensor correspond to the valid identification data of the sensor.

5. The electronic system according to claim 1, wherein the electronic system is configured to carry out the challenge-response type authentication of the user by implementing the following steps:
recovering, by the calculator, challenge data of the user memorised in the memory device, then
sending, from the calculator to the sensor, the challenge data of the user encrypted using the first encryption key, then
authentication measurement of the user by the sensor using the decrypted challenge data of the user, then
sending, from the sensor to the calculator, response data of the user corresponding to the authentication measurement of the user by the sensor, encrypted using the first encryption key, then
sending, from the calculator to the memory device, the decrypted response data of the user, then
comparing the response data of the user and the valid identification data of the user, the user being authenticated as valid if the response data of the user correspond to the valid identification data of the user.

6. The electronic system according to claim 1, wherein the electronic system is configured to:
calculate, after the challenge-response type authentication of the user, a second encryption key based on the challenge data of the user and the response data of the user, the second encryption key being shared between the calculator and the sensor, then
calculate a third encryption key based on the first and second encryption keys and shared between the calculator and the sensor, then
exchange encrypted data between the sensor and the calculator using the third encryption key.

7. The electronic system according to claim 1, wherein the electronic system is configured to implement, periodically or not, and after a first challenge-response type authentication of the user:
another challenge-response type authentication of the sensor, wherein the response data of the sensor are intended to be generated by the PUF of the sensor, and/or
another challenge-response type authentication of the user, during which the data exchanged between the calculator and the sensor are encrypted using the first encryption key or another encryption key calculated based on the challenge data of the sensor and the response data of the sensor obtained during said other challenge-response type authentication of the sensor.

8. The electronic system according to claim 1, wherein the memory device includes a database remote from the sensor and from the calculator.

9. The electronic system according to claim 1, wherein the sensor and the calculator are part of an electronic device corresponding to a smartphone, or an electronic watch connected to the Internet, or extended-reality glasses connected to the Internet.

10. A method for challenge-response type authentication of a user, implemented in an electronic system according to claim 1.
